(19) United States
(12) Patent Application Publication
(10) Pub. No.: US 2025/0258350 A1
(43) Pub. Date: Aug. 14, 2025

(54) 3D Co-Packaged Optics Stack

(71) Applicant: II-VI Delaware, Inc., Wilmington, DE (US)

(72) Inventors: Young-Kai Chen, Berkeley Heights, NJ (US); Anna Tatarczak, Felton, CA (US); Chris Kocot, Redwood City, CA (US); Vipul Bhatt, Los Altos, CA (US); Julie Eng, Warrendale, PA (US)

(21) Appl. No.: 19/051,470

(22) Filed: Feb. 12, 2025

Related U.S. Application Data
(60) Provisional application No. 63/552,300, filed on Feb. 12, 2024.

(51) Int. Cl. G02B 6/42; G02B 6/43

(52) U.S. Cl. CPC G02B 6/428; G02B 6/4204; G02B 6/4245; G02B 6/4249; G02B 6/4266; G02B 6/43

(57) ABSTRACT

A 3D co-packaged optics (CPO) stack device may include a thermal management and control layer, a printed circuit board (PCB) layer, a processing layer, a transimpedance amplifier and driver (TIA/Driver) electrical integrated circuit (EIC) layer, and a photonic integrated circuit (PIC) layer. The thermal management and control layer is positioned on a first surface of the PCB layer, a first surface of the processing layer is positioned on a second surface of the PCB layer, a first surface of the TIA/Driver EIC layer is positioned on a second surface of the processing layer, and a first surface of the PIC layer is positioned on a second surface of the TIA/Driver EIC layer.

### CROSS REFERENCE TO RELATED APPLICATION

This application claims priority to U.S. Provisional Patent Application No. 63/552,300, filed Feb. 12, 2024, the disclosure of which is hereby incorporated by reference in its entirety.

### BACKGROUND

### 1. Field

This disclosed subject matter relates generally to devices used in fiber-optic communication and, in some non-limiting embodiments, to a 3D co-packaged optics (CPO) stack.

### 2. Technical Considerations

Optical communication (e.g., optical telecommunication) may refer to a method of communication between two locations at a distance apart using light to carry information. An optical communication system may use a transmitter, which encodes a message into an optical signal, a channel, which carries the optical signal to its destination, and a receiver, which reproduces the message from the optical signal that is received by the receiver.

Fiber-optic communication may refer to a form of optical communication that involves transmitting information from one place to another by sending pulses of light (e.g., infrared light) through an optical fiber. The light may be used as a form of carrier wave that is modulated to carry the information. Optical fiber may be preferred over electrical cabling in specific situations, such as when high bandwidth, long distance, and/or immunity to electromagnetic interference is required. Fiber-optic communication can transmit voice, video, and telemetry through local area networks or across long distances.

Some fiber-optic communication systems may involve the use of electrical components and optical components. However, some of the electrical components used in such systems, such as copper circuits, may result in signal degradation and distortion, which may become more pronounced as the length of circuits and the number of electrical circuit components increase. Additionally, many components of fiber-optic communication systems may rely on devices that are constructed using individual integrated circuit packaging techniques. Such techniques may involve encapsulated separate dies in supporting cases, which prevent physical damage and corrosion, and then connecting the dies to the external circuitry using wire bonds and/or solder bumps, for example. However, such traditional integrated circuit packaging techniques may result in larger than desired devices which consume relatively large amounts of power.

### SUMMARY

Accordingly, it is an object of the presently disclosed subject matter to provide an optical waveguide interferometer that overcomes some or all of the deficiencies of the prior art. According to non-limiting embodiments, provided is a 3D co-packaged optics (CPO) stack device. In some non-limiting embodiments, the 3D CPO stack device may include a thermal management and control layer. In some non-limiting embodiments, the 3D CPO stack device may further include a printed circuit board (PCB) layer. In some non-limiting embodiments, the 3D CPO stack device may further include a processing layer. In some non-limiting embodiments, the 3D CPO stack device may include a transimpedance amplifier and driver (TIA/Driver) electrical integrated circuit (EIC) layer. In some non-limiting embodiments, the 3D CPO stack device may further include a photonic integrated circuit (PIC) layer. In some non-limiting embodiments, the thermal management and control layer may be positioned on a first surface of the PCB layer. In some non-limiting embodiments, a first surface of the processing layer may be positioned on a second surface of the PCB layer. In some non-limiting embodiments, the second surface of the PCB layer may be opposite the first surface of the PCB layer. In some non-limiting embodiments, a first surface of the TIA/Driver EIC layer may be positioned on a second surface of the processing layer. In some non-limiting embodiments, the second surface of the processing layer may be opposite the first surface of the processing layer. In some non-limiting embodiments, a first surface of the PIC layer may be positioned on a second surface of the TIA/Driver EIC layer. In some non-limiting embodiments, the second surface of the TIA/Driver EIC layer may be opposite the first surface of the TIA/Driver EIC layer.

In some non-limiting embodiments, the PIC layer may include at least one of the following a plurality of laser devices; a plurality of photodetectors (PDs), a plurality of modulator devices, or any combination thereof.

In some non-limiting embodiments, the 3D CPO stack device may further include an optical interposer layer. In some non-limiting embodiments, a first surface of the optical interposer layer may be positioned on a second surface of the PIC layer. In some non-limiting embodiments, the second surface of the PIC layer may be opposite the first surface of the PIC layer.

In some non-limiting embodiments, the 3D CPO stack device may further include an optical fiber array coupled to the optical interposer layer.

In some non-limiting embodiments, the optical fiber array may be coupled to a second surface of the optical interposer layer. In some non-limiting embodiments, the second surface of the optical interposer layer may be opposite the first surface of the optical interposer layer.

In some non-limiting embodiments, a first end of the optical fiber array may be coupled to the second surface of the optical interposer layer. In some non-limiting embodiments, the 3D CPO stack device may further include at least one fiber connector coupled to a second end of the optical fiber array. In some non-limiting embodiments, the at least one fiber connector may provide a redirected path for light from an original path provided by the optical fiber array.

In some non-limiting embodiments, the optical interposer layer may include a plurality of layers of waveguides and a plurality of coupling elements. In some non-limiting embodiments, the plurality of coupling elements may be configured to couple light between adjacent layers of waveguides of the plurality of layers of waveguides.

In some non-limiting embodiments, the PIC layer may be formed on the TIA/Driver EIC layer based on a flip-chip bonding procedure.

In some non-limiting embodiments, the PIC layer may be constructed based on at least one of the following a procedure involving silicon photonics (SiPho), a procedure involving indium phosphide (InP), a procedure involving Gallium Arsenide (GaAs), or any combination thereof.

In some non-limiting embodiments, the processing layer may include an application specific integrated circuit (ASIC).

In some non-limiting embodiments, the processing layer may be constructed based on a procedure involving complementary metal-oxide-semiconductor (CMOS) ultra-large-scale Integration (ULSI).

In some non-limiting embodiments, provided is a 3D co-packaged optics (CPO) stack device. In some non-limiting embodiments, the 3D CPO stack device may include a thermal management and control layer. In some non-limiting embodiments, the 3D CPO stack device may further include a printed circuit board (PCB) layer. In some non-limiting embodiments, the 3D CPO stack device may further include a processing layer. In some non-limiting embodiments, the 3D CPO stack device may further include a transimpedance amplifier and driver (TIA/Driver) electrical integrated circuit (EIC) layer. In some non-limiting embodiments, the 3D CPO stack device may further include a laser and photodetector layer. In some non-limiting embodiments, the thermal management and control layer may be positioned on a first surface of the PCB layer. In some non-limiting embodiments, a first surface of the processing layer may be positioned on a second surface of the PCB layer. In some non-limiting embodiments, the second surface of the PCB layer may be opposite the first surface of the PCB layer. In some non-limiting embodiments, a first surface of the TIA/Driver EIC layer may be positioned on a second surface of the processing layer. In some non-limiting embodiments, the second surface of the processing layer may be opposite the first surface of the processing layer. In some non-limiting embodiments, a first surface of the laser and photodetector layer may be positioned on a second surface of the TIA/Driver EIC layer. In some non-limiting embodiments, the second surface of the TIA/Driver EIC layer may be opposite the first surface of the TIA/Driver EIC layer.

In some non-limiting embodiments, the 3D CPO stack device may further include an optical interposer layer. In some non-limiting embodiments, a first surface of the optical interposer layer may be positioned on a second surface of the laser and photodetector layer. In some non-limiting embodiments, the second surface of the PIC layer may be opposite the first surface of the laser and photodetector layer.

In some non-limiting embodiments, the laser and photodetector layer may include a plurality of laser devices. In some non-limiting embodiments, the plurality of laser devices may include at least one of the following a vertical-cavity surface-emitting laser (VCSEL), a quantum dot (QD) laser, a light emitting diode laser, a distributed feedback laser, or any combination thereof.

In some non-limiting embodiments, the laser and photodetector layer may include a plurality of photodetectors (PDs). In some non-limiting embodiments, each laser device of the plurality of laser devices may be driven by a separate driver transmission channel and each PD of the plurality of PDs may be coupled to a separate transimpedance amplifier (TIA) and receiving channel.

In some non-limiting embodiments, the laser and photodetector layer may include a lens corresponding to each laser device of the plurality of laser devices to provide for collimation of light beams provided by the plurality of laser devices.

In some non-limiting embodiments, the laser and photodetector layer may be formed with the TIA/Driver EIC layer on the processing layer based on a flip-chip bonding procedure.

According to some non-limiting embodiments, provided is a 3D co-packaged optics (CPO) stack device. In some non-limiting embodiments, the 3D CPO stack device may include a thermal management and control layer. In some non-limiting embodiments, the 3D CPO stack device may further include a printed circuit board (PCB) layer. In some non-limiting embodiments, the 3D CPO stack device may further include a processing layer. In some non-limiting embodiments, the processing layer may receive control signals from the thermal management and control layer. In some non-limiting embodiments, the 3D CPO stack device may further include a transimpedance amplifier and driver (TIA/Driver) electrical integrated circuit (EIC) layer. In some non-limiting embodiments, the 3D CPO stack device may further include a photonic integrated circuit (PIC) layer. In some non-limiting embodiments, the 3D CPO stack device may further include an optical interposer layer. In some non-limiting embodiments, the optical interposer layer may include a plurality of vias that are configured to guide light through the optical interposer layer. In some non-limiting embodiments, the 3D CPO stack device may further include and an optical fiber array coupled to the optical interposer layer. In some non-limiting embodiments, the thermal management and control layer may be positioned on a first surface of the PCB layer. In some non-limiting embodiments, a first surface of the processing layer may be positioned on a second surface of the PCB layer. In some non-limiting embodiments, the second surface of the PCB layer may be opposite the first surface of the PCB layer. In some non-limiting embodiments, a first surface of the TIA/Driver EIC layer may be positioned on a second surface of the processing layer. In some non-limiting embodiments, the second surface of the processing layer may be opposite the first surface of the processing layer. In some non-limiting embodiments, a first surface of the PIC layer may be positioned on a second surface of the TIA/Driver EIC layer. In some non-limiting embodiments, the second surface of the TIA/Driver EIC layer may be opposite the first surface of the TIA/Driver EIC layer. In some non-limiting embodiments, a first surface of the optical interposer layer may be positioned on a second surface of the PIC layer. In some non-limiting embodiments, the second surface of the PIC layer may be opposite the first surface of the PIC layer.

In some non-limiting embodiments, the optical fiber array may be coupled to a second surface of the optical interposer layer. In some non-limiting embodiments, the second surface of the optical interposer layer may be opposite the first surface of the optical interposer layer.

In some non-limiting embodiments, a first end of the optical fiber array may be coupled to the second surface of the optical interposer layer. In some non-limiting embodiments, the 3D CPO stack device may further include a first fiber connector coupled to a first portion of the optical fiber array at a second end of the optical fiber array. In some non-limiting embodiments, the first fiber connector may provide a first redirected path for light from an original path provided by the optical fiber array. In some non-limiting embodiments, the 3D CPO stack device may further include a second fiber connector coupled to a second portion of the optical fiber array at the second end of the optical fiber array. In some non-limiting embodiments, the second fiber connector may provide a second redirected path for light from an original path provided by the optical fiber array.

Further embodiments are set forth in the following numbered clauses:
Clause 1: A 3D co-packaged optics (CPO) stack device, comprising: a thermal management and control layer; a printed circuit board (PCB) layer; a processing layer; a transimpedance amplifier and driver (TIA/Driver) electrical integrated circuit (EIC) layer; and a photonic integrated circuit (PIC) layer; wherein the thermal management and control layer is positioned on a first surface of the PCB layer; wherein a first surface of the processing layer is positioned on a second surface of the PCB layer, and wherein the second surface of the PCB layer is opposite the first surface of the PCB layer; wherein a first surface of the TIA/Driver EIC layer is positioned on a second surface of the processing layer, and wherein the second surface of the processing layer is opposite the first surface of the processing layer; and wherein a first surface of the PIC layer is positioned on a second surface of the TIA/Driver EIC layer, and wherein the second surface of the TIA/Driver EIC layer is opposite the first surface of the TIA/Driver EIC layer.
Clause 2: The 3D CPO stack device of clause 1, wherein the PIC layer comprises at least one of the following: a plurality of laser devices; a plurality of photodetectors (PDs); a plurality of modulator devices; or any combination thereof.
Clause 3: The 3D CPO stack device of clause 1 or 2, further comprising: an optical interposer layer, wherein a first surface of the optical interposer layer is positioned on a second surface of the PIC layer, and wherein the second surface of the PIC layer is opposite the first surface of the PIC layer.
Clause 4: The 3D CPO stack device of any of clauses 1-3, further comprising: an optical fiber array coupled to the optical interposer layer.
Clause 5: The 3D CPO stack device of any of clauses 1-4, wherein the optical fiber array is coupled to a second surface of the optical interposer layer, and wherein the second surface of the optical interposer layer is opposite the first surface of the optical interposer layer.
Clause 6: The 3D CPO stack device of any of clauses 1-5, wherein a first end of the optical fiber array is coupled to the second surface of the optical interposer layer, the 3D CPO stack device further comprising: at least one fiber connector coupled to a second end of the optical fiber array, wherein the at least one fiber connector provides a redirected path for light from an original path provided by the optical fiber array.
Clause 7: The 3D CPO stack device of any of clauses 1-6, wherein the optical interposer layer comprises a plurality of layers of waveguides and a plurality of coupling elements, and wherein the plurality of coupling elements is configured to couple light between adjacent layers of waveguides of the plurality of layers of waveguides.
Clause 8: The 3D CPO stack device of any of clauses 1-7, wherein the PIC layer is formed on the TIA/Driver EIC layer based on a flip-chip bonding procedure.
Clause 9: The 3D CPO stack device of any of clauses 1-8, wherein the PIC layer is constructed based on at least one of the following: a procedure involving silicon photonics (SiPho); a procedure involving indium phosphide (InP); a procedure involving Gallium Arsenide (GaAs); or any combination thereof.
Clause 10: The 3D CPO stack device of any of clauses 1-9, wherein the processing layer comprises an application specific integrated circuit (ASIC).
Clause 11: The 3D CPO stack device of any of clauses 1-10, wherein the processing layer is constructed based on a procedure involving complementary metal-oxide-semiconductor (CMOS) ultra-large-scale Integration (ULSI).
Clause 12: A 3D co-packaged optics (CPO) stack device, comprising: a thermal management and control layer; a printed circuit board (PCB) layer; a processing layer; a transimpedance amplifier and driver (TIA/Driver) electrical integrated circuit (EIC) layer; and a laser and photodetector layer; wherein the thermal management and control layer is positioned on a first surface of the PCB layer; wherein a first surface of the processing layer is positioned on a second surface of the PCB layer, and wherein the second surface of the PCB layer is opposite the first surface of the PCB layer; wherein a first surface of the TIA/Driver EIC layer is positioned on a second surface of the processing layer, and wherein the second surface of the processing layer is opposite the first surface of the processing layer; and wherein a first surface of the laser and photodetector layer is positioned on a second surface of the TIA/Driver EIC layer, and wherein the second surface of the TIA/Driver EIC layer is opposite the first surface of the TIA/Driver EIC layer.
Clause 13: The 3D CPO stack device of clause 12, further comprising: an optical interposer layer, wherein a first surface of the optical interposer layer is positioned on a second surface of the laser and photodetector layer, and wherein the second surface of the PIC layer is opposite the first surface of the laser and photodetector layer.
Clause 14: The 3D CPO stack device of clause 12 or 13, wherein the laser and photodetector layer comprises a plurality of laser devices, and wherein the plurality of laser devices comprises at least one of the following: a vertical-cavity surface-emitting laser (VCSEL); a quantum dot (QD) laser; a light emitting diode laser; a distributed feedback laser; or any combination thereof.
Clause 15: The 3D CPO stack device of any of clauses 12-14, wherein the laser and photodetector layer comprises a plurality of photodetectors (PDs), and wherein each laser device of the plurality of laser devices is driven by a separate driver transmission channel and each PD of the plurality of PDs is coupled to a separate transimpedance amplifier (TIA) and receiving channel.
Clause 16: The 3D CPO stack device of any of clauses 12-15, wherein the laser and photodetector layer comprises a lens corresponding to each laser device of the plurality of laser devices to provide for collimation of light beams provided by the plurality of laser devices.
Clause 17: The 3D CPO stack device of any of clauses 12-16, wherein the laser and photodetector layer is formed with the TIA/Driver EIC layer on the processing layer based on a flip-chip bonding procedure.
Clause 18: A 3D co-packaged optics (CPO) stack device, comprising: a thermal management and control layer; a printed circuit board (PCB) layer; a processing layer, wherein the processing layer receives control signals from the thermal management and control layer; a transimpedance amplifier and driver (TIA/Driver) electrical integrated circuit (EIC) layer; a photonic integrated circuit (PIC) layer; an optical interposer layer, wherein the optical interposer layer comprises a plurality of vias that are configured to guide light through the optical interposer layer; and an optical fiber array coupled to the optical interposer layer; wherein the thermal management and control layer is positioned on a first surface of the PCB layer; wherein a first surface of the processing layer is positioned on a second surface of the PCB layer, and wherein the second surface of the PCB layer is opposite the first surface of the PCB layer; wherein a first surface of the TIA/Driver EIC layer is positioned on a second surface of the processing layer, and wherein the second surface of the processing layer is opposite the first surface of the processing layer; wherein a first surface of the PIC layer is positioned on a second surface of the TIA/Driver EIC layer, and wherein the second surface of the TIA/Driver EIC layer is opposite the first surface of the TIA/Driver EIC layer; and wherein a first surface of the optical interposer layer is positioned on a second surface of the PIC layer, and wherein the second surface of the PIC layer is opposite the first surface of the PIC layer.
Clause 19: The 3D CPO stack device of clause 18, wherein the optical fiber array is coupled to a second surface of the optical interposer layer, and wherein the second surface of the optical interposer layer is opposite the first surface of the optical interposer layer.
Clause 20: The 3D CPO stack device of clause 18 or 19, wherein a first end of the optical fiber array is coupled to the second surface of the optical interposer layer, the 3D CPO stack device further comprising: a first fiber connector coupled to a first portion of the optical fiber array at a second end of the optical fiber array, wherein the first fiber connector provides a first redirected path for light from an original path provided by the optical fiber array; and a second fiber connector coupled to a second portion of the optical fiber array at the second end of the optical fiber array, wherein the second fiber connector provides a second redirected path for light from an original path provided by the optical fiber array.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular forms of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments that are illustrated in the accompanying figures, in which:

FIG. 1 is a diagram of a non-limiting embodiment of a 3D co-packaged optics (CPO) stack device;

FIG. 2 is a diagram of another non-limiting embodiment of a 3D CPO stack device;

FIG. 3 is a diagram of another non-limiting embodiment of a 3D CPO stack device;

FIG. 4 is a diagram of another non-limiting embodiment of a 3D CPO stack device; and

FIG. 5 is a diagram of another non-limiting embodiment of a 3D CPO stack device.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments of the disclosed subject matter. Hence, specific dimensions and other physical characteristics related to the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

Advanced packaging may refer to an aggregation and interconnection of components before traditional integrated circuit packaging where a single die is packaged. Advanced packaging may allow for multiple devices, including electrical, mechanical, and/or semiconductor devices, to be merged and packaged as a single electronic device. Advanced packaging uses processes and techniques that are typically performed at semiconductor fabrication facilities. Co-packaged optics (CPO) may refer to a technology that enables the integration of optical components directly into a processor component to address bandwidth and power challenges. In addition, CPO may allow for the direct integration of different chips onto a shared base material, saving power and expanding bandwidth. Further, CPO may help to address the problem of overloading the number of optical modules after ultra-high computing power, and the optical engine is moved near the processor component to reduce the transmission distance and improve the quality of high-speed electrical signal transmission.

According to non-limiting embodiments of the present disclosure, a 3D CPO stack device may include a thermal management and control layer, a Printed Circuit Board (PCB) layer, a processing layer, a Transimpedance Amplifier and Driver (TIA/Driver) Electrical Integrated Circuit (EIC) layer, and a Photonic Integrated Circuit (PIC) layer. In some non-limiting embodiments, the thermal management and control layer is positioned on a first surface of the PCB layer. In some non-limiting embodiments, a first surface of the processing layer is positioned on a second surface of the PCB layer, wherein the second surface of the PCB layer is opposite the first surface of the PCB layer. In some non-limiting embodiments, a first surface of the TIA/Driver EIC layer is positioned on a second surface of the processing layer, wherein the second surface of the processing layer is opposite the first surface of the processing layer. In some non-limiting embodiments, a first surface of the PIC layer is positioned on a second surface of the TIA/Driver EIC layer, wherein the second surface of the TIA/Driver EIC layer is opposite the first surface of the TIA/Driver EIC layer.

In some non-limiting embodiments, the PIC layer comprises at least one of the following: a plurality of laser devices, a plurality of photodetectors (PDs), a plurality of modulator devices, or any combination thereof.

In some non-limiting embodiments, the 3D CPO stack device may further include an optical interposer layer, wherein a first surface of the optical interposer layer is positioned on a second surface of the PIC layer, where the second surface of the PIC layer is opposite the first surface of the PIC layer.

In some non-limiting embodiments, the 3D CPO stack device may further include an optical fiber array coupled to the optical interposer layer.

In some non-limiting embodiments, the optical fiber array is coupled to a second surface of the optical interposer layer, wherein the second surface of the optical interposer layer is opposite the first surface of the optical interposer layer.

In some non-limiting embodiments, a first end of the optical fiber array is coupled to the second surface of the optical interposer layer, the 3D CPO stack device further includes at least one fiber connector coupled to a second end of the optical fiber array, wherein the at least one fiber connector provides a redirected path for light from an original path provided by the optical fiber array.

In some non-limiting embodiments, the optical interposer layer may include a plurality of layers of waveguides and a plurality of coupling elements, wherein the plurality of coupling elements is configured to couple light between adjacent layers of waveguides of the plurality of layers of waveguides.

In some non-limiting embodiments, the PIC layer is formed on the TIA/Driver EIC layer based on a flip-chip bonding procedure.

In some non-limiting embodiments, the PIC layer is constructed based on at least one of the following: a procedure involving silicon photonics (SiPho), a procedure involving indium phosphide (InP), a procedure involving Gallium Arsenide (GaAs), or any combination thereof.

In some non-limiting embodiments, the processing layer may include an application specific integrated circuit (ASIC).

In some non-limiting embodiments, the processing layer is constructed based on a procedure involving complementary metal-oxide-semiconductor (CMOS) ultra-large-scale Integration (ULSI).

In this way, the 3D CPO stack device may provide for high input and output density and throughput. With this configuration, high density high speed 2D electrical I/O channels may be delivered from the top of the 3D CPO stack device into the vertical CPO layers. In some non-limiting embodiments, the optical interposer layer may be introduced on top of the PIC layer (e.g., the 2D actives and passives of the PIC layer) to couple light either vertically or horizontally. In addition, the light-carrying channels may be coupled through an MPO connector with a fiber bundle or may be transmitted in free space to other optical devices.

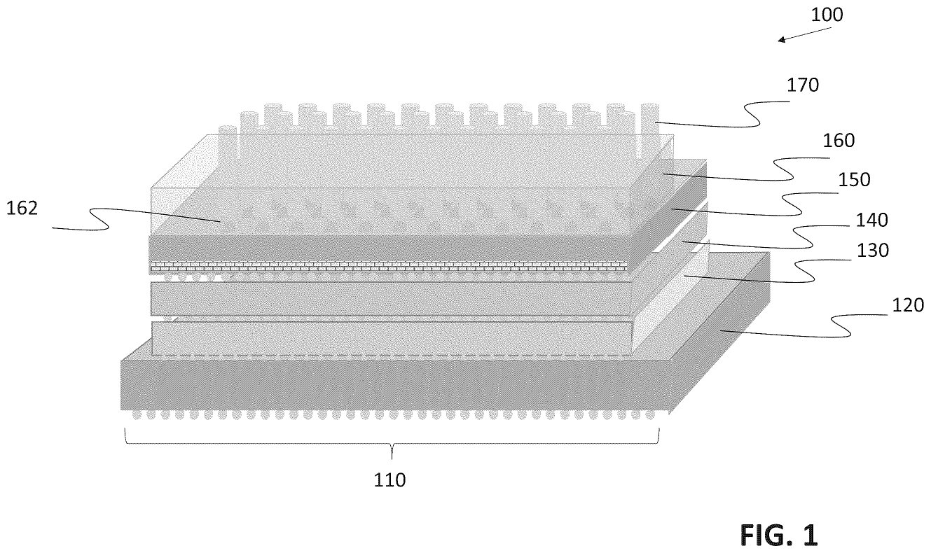

Referring now to FIG. 1, FIG. 1 is a diagram of a non-limiting embodiment of 3D CPO stack device 100. As shown in FIG. 1, 3D CPO stack device 100 may include thermal management and control layer 110, PCB layer 120, processing layer 130, TIA/Driver EIC layer 140, PIC layer 150, optical interposer layer 160, and optical fiber array 170. In some non-limiting embodiments, optical interposer layer 160 may include a plurality of vias 162 that are configured to guide light through optical interposer layer 160 (e.g., may guide light vertically up and out of 3D CPO stack device 100 or turn and guide light to a side of 3D CPO stack device 100). As further shown in FIG. 1, thermal management and control layer 110 may be positioned on a first surface (e.g., a bottom surface) of PCB layer 120, and a first surface (e.g., a bottom surface) of processing layer 130 is positioned on a second surface (e.g., a top surface) of PCB layer 120. In some non-limiting embodiments, the second surface of PCB layer 120 is opposite the first surface of PCB layer 120.

As further shown in FIG. 1, a first surface (e.g., a bottom surface) of TIA/Driver EIC layer 140 is positioned on a second surface (e.g., a top surface) of processing layer 130, where the second surface of processing layer 130 is opposite the first surface of processing layer 130, and a first surface (e.g., a bottom surface) of the PIC layer 150 is positioned on a second surface (e.g., a top surface) of TIA/Driver EIC layer 140, where the second surface of TIA/Driver EIC layer 140 is opposite the first surface of TIA/Driver EIC layer 140.

As further shown in FIG. 1, a first surface (e.g., a bottom surface) of optical interposer layer 160 is positioned on a second surface (e.g., a top surface) of PIC layer 150, wherein the second surface of PIC layer 150 is opposite the first surface of PIC layer 150. As further shown in FIG. 1, optical fiber array 170 may be coupled (e.g., connected) to optical interposer layer 160. In some non-limiting embodiments, optical fiber array 170 may be coupled to a second surface (e.g., a top surface) of optical interposer layer 160, where the second surface of optical interposer layer 160 is opposite the first surface of optical interposer layer 160. In some non-limiting embodiments, each optical fiber of optical fiber array 170 may be aligned with each via 162 of the plurality of vias 162. In some non-limiting embodiments, optical fiber array 170 may carry an optical modulated signal out, an optical modulated signal in, and/or an optical continuous wave (CW) pump laser signal.

In some non-limiting embodiments, PIC layer 150 may include at least one of the following: a plurality of laser devices, a plurality of PDs, a plurality of modulator devices, or any combination thereof. In some non-limiting embodiments, each modulator of the plurality of modulators may be driven individually by a separate driver transmission channel and/or each PD of the plurality of PDs may be connected to a separate TIA and receiving channel.

In some non-limiting embodiments, PIC layer 150 may include one or more waveguides. In some non-limiting embodiments, a waveguide of PIC layer 150 may include a 2D grating coupler array implemented for each lane to be vertically coupled into and/or out of 3D CPO stack device 100. The couplers of the 2D grating coupler array may be distributed in the form of a 2D array, and the couplers may correspond to a fiber connector and/or an optical fiber bundle (e.g., optical fiber array 170) positioned above PIC layer 150.

In some non-limiting embodiments, and depending on a thermal cooling implementation, a laser of PIC layer 150 may be co-integrated with PIC layer 150 with a modulator or may be external (e.g., a continuous wavelength (CW) light source coupled into 3D CPO stack device 100 from a remote laser). In some non-limiting embodiments, high temperature integrated light sources, modulators, PDs, and/or the like, may include Gallium arsenide (GaAs) based devices, Indium phosphide (InP) based devices, Gallium nitride (GaN) based devices, Gallium phosphide (GaP) based devices, or other similar platforms.

In some non-limiting embodiments, PIC layer 150 may be constructed based on at least one of the following: a procedure (e.g., a manufacturing procedure, such as a semiconductor manufacturing procedure) involving SiPho, a procedure involving InP, a procedure involving GaAs; or any combination thereof. In some non-limiting embodiments, PIC layer 150 may be formed on TIA/Driver EIC layer 140 based on a flip-chip bonding procedure. In some non-limiting embodiments, PIC layer 150 may be formed with TIA/Driver EIC layer 140 on processing layer 130 based on a flip-chip bonding procedure. In some non-limiting embodiments, a layout of lasers, modulators, and/or PDs of PIC layer 150 and/or optical interposer layer 160 may be collimated and may correspond to a fiber connector and/or an optical fiber bundle (e.g., optical fiber array 170) positioned above PIC layer 150.

In some non-limiting embodiments, PIC layer 150 may include a laser and a photodetector layer. In some non-limiting embodiments, the laser and photodetector layer may include a plurality of laser devices (e.g., a plurality of 2D laser arrays), wherein the plurality of laser devices comprises at least one of the following: a vertical-cavity surface-emitting laser (VCSEL), a quantum dot (QD) laser, a light emitting diode (LED) laser (e.g., such as a uLED laser), a distributed feedback laser, or any combination thereof. In some non-limiting embodiments, the laser and photodetector layer may include a plurality of PDs (e.g., a plurality of 2D PD arrays), wherein each laser device of the plurality of laser devices is driven by a separate driver transmission channel and each PD of the plurality of PDs is coupled to a separate TIA and receiving channel. In some non-limiting embodiments, the laser and photodetector layer may include a lens corresponding to each laser device of the plurality of laser devices to provide for collimation of light beams provided by the plurality of laser devices. In some non-limiting embodiments, the laser and photodetector layer may be formed with TIA/Driver EIC layer 140 on processing layer 130 based on a flip-chip bonding procedure.

In some non-limiting embodiments, optical interposer layer 160 may include a plurality of layers of waveguides and/or a plurality of coupling elements (e.g., grating couplers and/or waveguide tapers). In some non-limiting embodiments, the plurality of coupling elements is configured to couple light between adjacent layers of waveguides of the plurality of layers of waveguides.

In some non-limiting embodiments, optical interposer layer 160 may include a material, such as glass, silicon, and/or the like. In some non-limiting embodiments, optical interposer layer 160 may be integrated with other components of 3D CPO stack device 100 using a system-in-package (SiP) procedure. In some non-limiting embodiments, a micro-lens array may be integrated on optical interposer layer 160 to couple optical fiber array 170. In some non-limiting embodiments, optical interposer layer 160 may guide light from a 2D array (e.g., a 2D array of PIC layer 150) to a side of 3D CPO stack device 100 and outcouple the light in a 2D array.

In some non-limiting embodiments, processing layer 130 may include an ASIC. In some non-limiting embodiments, processing layer 130 may include a field programmable gate array (FPGA). In some non-limiting embodiments, processing layer 130 may be constructed based on a procedure involving CMOS ULSI.

In some non-limiting embodiments, 3D CPO stack device 100 may be used to transmit a light output (e.g., an outcoupled collimated 2D light) in free space to a neighboring device (e.g., a module receiver, such as another 3D CPO stack device 100) in a server rack without a need for a coupling to an optical fiber.

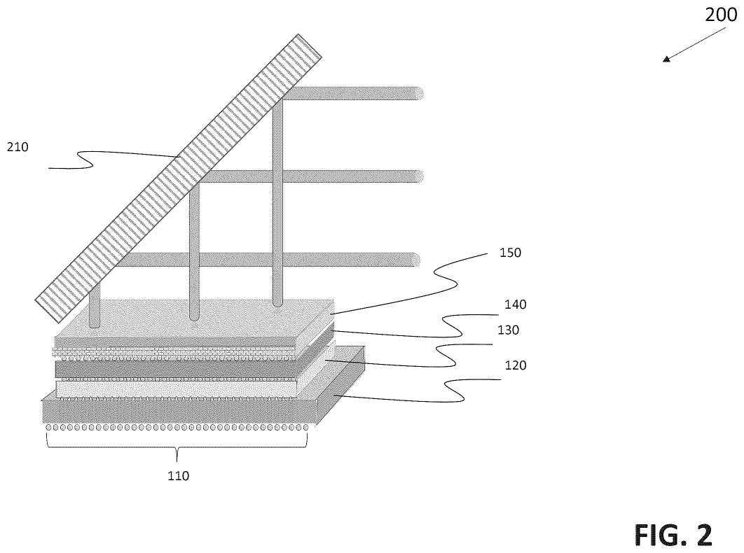

Referring now to FIG. 2, FIG. 2 is a diagram of a non-limiting embodiment of 3D CPO stack device 200. In some non-limiting embodiments, 3D CPO stack device 200 may be the same as or similar to 3D CPO stack device 100. As shown in FIG. 2, 3D CPO stack device 200 may include thermal management and control layer 110, PCB layer 120, processing layer 130, TIA/Driver EIC layer 140, PIC layer 150, and mirror 210. It is noted that 3D CPO stack device 200 does not include (e.g., is independent of) optical interposer layer 160 and optical fiber array 170. In some non-limiting embodiments, mirror 210 mirror may be used to turn light (e.g., coupled light) to a side, while maintaining the 2D light output array (e.g., the 2D light output array of PIC layer 150) of 3D CPO stack device 200.

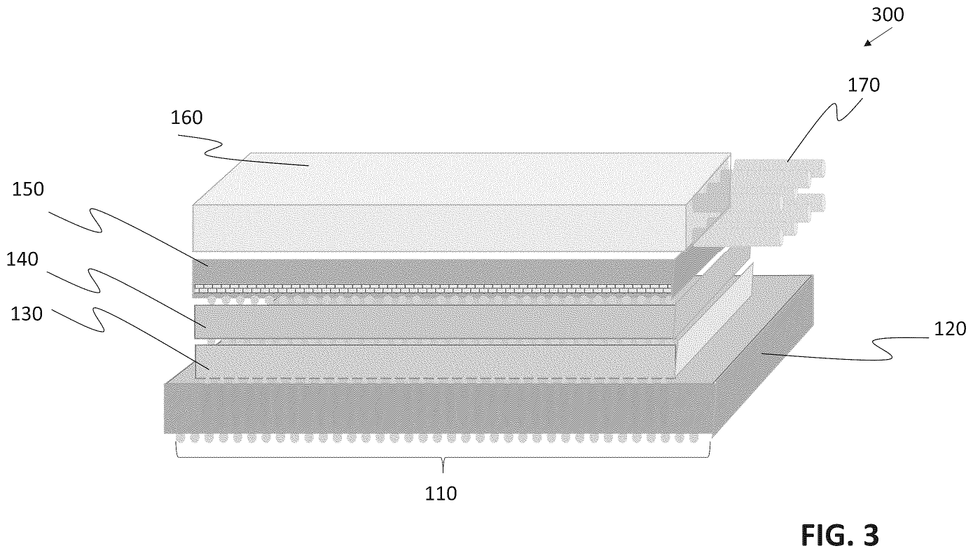

Referring now to FIG. 3, FIG. 3 is a diagram of a non-limiting embodiment of 3D CPO stack device 300. In some non-limiting embodiments, 3D CPO stack device 300 may be the same as or similar to 3D CPO stack device 100 and/or 3D CPO stack device 200. As shown in FIG. 3, 3D CPO stack device 300 may include thermal management and control layer 110, PCB layer 120, processing layer 130, TIA/Driver EIC layer 140, PIC layer 150, optical interposer layer 160, and optical fiber array 170. As further shown in FIG. 3, optical fiber array 170 may be coupled to a side surface of optical interposer layer 160. In this way, 3D CPO stack device 300 may allow for light (e.g., coupled light) to be redirected along a path from an original path provided by the layers of 3D CPO stack device 300. For example, the light may be redirected along a path that is approximately 90 degrees away from the original path.

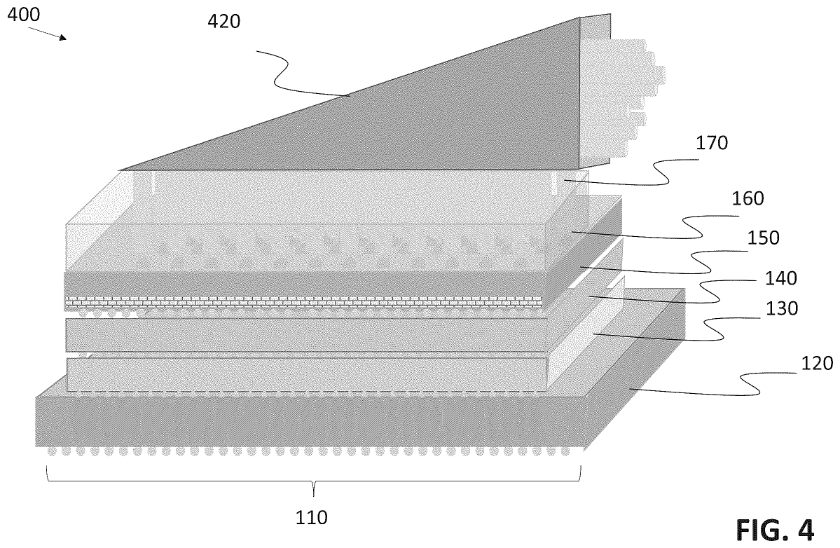

Referring now to FIG. 4, FIG. 4 is a diagram of a non-limiting embodiment of 3D CPO stack device 400. In some non-limiting embodiments, 3D CPO stack device 400 may be the same as or similar to 3D CPO stack device 100, 3D CPO stack device 200, and/or 3D CPO stack device 300. As shown in FIG. 4, 3D CPO stack device 400 may include thermal management and control layer 110, PCB layer 120, processing layer 130, TIA/Driver EIC layer 140, PIC layer 150, optical interposer layer 160, optical fiber array 170, and fiber connector 420. As further shown in FIG. 4, a first end of optical fiber array 170 is coupled to a second surface (e.g., a top surface) of optical interposer layer 160 and a second end of optical fiber array is coupled to fiber connector 420. In some non-limiting embodiments, fiber connector 420 may provide a redirected path for light from an original path provided by optical fiber array 170. For example, the light may be redirected along a path that is approximately 90 degrees away from the original path. In some non-limiting embodiments, fiber connector 420 may include a Multi-Fiber Push-On (MPO) connector or a type of fiber ribbon with more than one fiber laid out in a 2D fiber bundle. In some non-limiting embodiments, a turn may be implemented in fiber connector 420.

In some non-limiting embodiments, fiber connector 420 may be placed at a range of distances away from the light output by (e.g., outcoupled light that provided by) 3D CPO stack device 400. In this way, a free space link may maintain the light collimation of the light output.

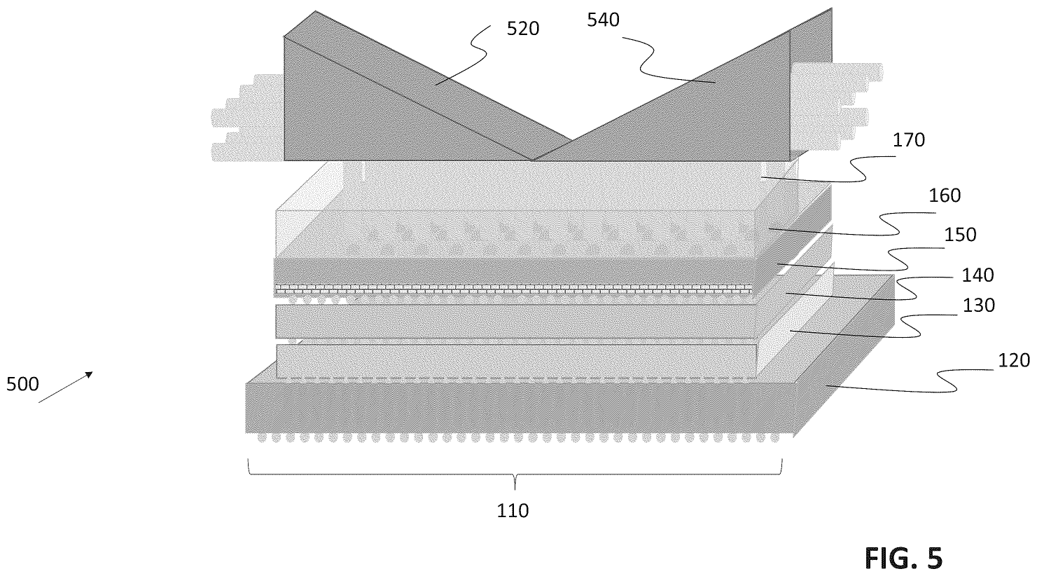

Referring now to FIG. 5, FIG. 5 is a diagram of a non-limiting embodiment of 3D CPO stack device 500. In some non-limiting embodiments, 3D CPO stack device 500 may be the same as or similar to 3D CPO stack device 100, 3D CPO stack device 200, 3D CPO stack device 300, and/or 3D CPO stack device 400. As shown in FIG. 4, 3D CPO stack device 400 may include thermal management and control layer 110, PCB layer 120, processing layer 130, TIA/Driver EIC layer 140, PIC layer 150, optical interposer layer 160, optical fiber array 170, first fiber connector 520, and second fiber connector 540. As further shown in FIG. 5, a first end of optical fiber array 170 is coupled to a second surface of optical interposer layer 160, first fiber connector 520 is coupled to a first portion of optical fiber array 170 at a second end of optical fiber array 170, where first fiber connector 520 provides a first redirected path for light from an original path provided by optical fiber array 170. In addition, second fiber connector 540 is coupled to a second portion of optical fiber array 170 at the second end of optical fiber array 170, where second fiber connector 540 provides a second redirected path for light from an original path provided by optical fiber array 170. In some non-limiting embodiments, the first fiber connector 520 and second fiber connector 540 face in opposite directions, such that the first redirected path for light and the second redirected path for light are in opposite directions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A 3D co-packaged optics (CPO) stack device, comprising:
a thermal management and control layer;
a printed circuit board (PCB) layer;
a processing layer;
a transimpedance amplifier and driver (TIA/Driver) electrical integrated circuit (EIC) layer; and
a photonic integrated circuit (PIC) layer;
wherein the thermal management and control layer is positioned on a first surface of the PCB layer;
wherein a first surface of the processing layer is positioned on a second surface of the PCB layer, and wherein the second surface of the PCB layer is opposite the first surface of the PCB layer;
wherein a first surface of the TIA/Driver EIC layer is positioned on a second surface of the processing layer, and wherein the second surface of the processing layer is opposite the first surface of the processing layer; and
wherein a first surface of the PIC layer is positioned on a second surface of the TIA/Driver EIC layer, and wherein the second surface of the TIA/Driver EIC layer is opposite the first surface of the TIA/Driver EIC layer.

2. The 3D CPO stack device of claim 1, wherein the PIC layer comprises at least one of the following:
a plurality of laser devices;
a plurality of photodetectors (PDs);
a plurality of modulator devices; or
any combination thereof.

3. The 3D CPO stack device of claim 1, further comprising:
an optical interposer layer, wherein a first surface of the optical interposer layer is positioned on a second surface of the PIC layer, and wherein the second surface of the PIC layer is opposite the first surface of the PIC layer.

4. The 3D CPO stack device of claim 3, further comprising:
an optical fiber array coupled to the optical interposer layer.

5. The 3D CPO stack device of claim 4, wherein the optical fiber array is coupled to a second surface of the optical interposer layer, and wherein the second surface of the optical interposer layer is opposite the first surface of the optical interposer layer.

6. The 3D CPO stack device of claim 4, wherein a first end of the optical fiber array is coupled to the second surface of the optical interposer layer, the 3D CPO stack device further comprising:
at least one fiber connector coupled to a second end of the optical fiber array, wherein the at least one fiber connector provides a redirected path for light from an original path provided by the optical fiber array.

7. The 3D CPO stack device of claim 3, wherein the optical interposer layer comprises a plurality of layers of waveguides and a plurality of coupling elements, and wherein the plurality of coupling elements is configured to couple light between adjacent layers of waveguides of the plurality of layers of waveguides.

8. The 3D CPO stack device of claim 1, wherein the PIC layer is formed on the TIA/Driver EIC layer based on a flip-chip bonding procedure.

9. The 3D CPO stack device of claim 1, wherein the PIC layer is constructed based on at least one of the following:
a procedure involving silicon photonics (SiPho);
a procedure involving indium phosphide (InP);
a procedure involving Gallium Arsenide (GaAs); or
any combination thereof.

10. The 3D CPO stack device of claim 1, wherein the processing layer comprises an application specific integrated circuit (ASIC).

11. The 3D CPO stack device of claim 10, wherein the processing layer is constructed based on a procedure involving complementary metal-oxide-semiconductor (CMOS) ultra-large-scale Integration (ULSI).

12. A 3D co-packaged optics (CPO) stack device, comprising:
a thermal management and control layer;
a printed circuit board (PCB) layer;
a processing layer;
a transimpedance amplifier and driver (TIA/Driver) electrical integrated circuit (EIC) layer; and
a laser and photodetector layer;
wherein the thermal management and control layer is positioned on a first surface of the PCB layer;
wherein a first surface of the processing layer is positioned on a second surface of the PCB layer, and wherein the second surface of the PCB layer is opposite the first surface of the PCB layer;
wherein a first surface of the TIA/Driver EIC layer is positioned on a second surface of the processing layer, and wherein the second surface of the processing layer is opposite the first surface of the processing layer; and
wherein a first surface of the laser and photodetector layer is positioned on a second surface of the TIA/Driver EIC layer, and wherein the second surface of the TIA/Driver EIC layer is opposite the first surface of the TIA/Driver EIC layer.

13. The 3D CPO stack device of claim 12, further comprising:
an optical interposer layer, wherein a first surface of the optical interposer layer is positioned on a second surface of the laser and photodetector layer, and wherein the second surface of the PIC layer is opposite the first surface of the laser and photodetector layer.

14. The 3D CPO stack device of claim 12, wherein the laser and photodetector layer comprises a plurality of laser devices, and wherein the plurality of laser devices comprises at least one of the following:
a vertical-cavity surface-emitting laser (VCSEL);
a quantum dot (QD) laser;
a light emitting diode laser;
a distributed feedback laser; or
any combination thereof.

15. The 3D CPO stack device of claim 14, wherein the laser and photodetector layer comprises a plurality of photodetectors (PDs), and wherein each laser device of the plurality of laser devices is driven by a separate driver transmission channel and each PD of the plurality of PDs is coupled to a separate transimpedance amplifier (TIA) and receiving channel.

16. The 3D CPO stack device of claim 14, wherein the laser and photodetector layer comprises a lens corresponding to each laser device of the plurality of laser devices to provide for collimation of light beams provided by the plurality of laser devices.

17. The 3D CPO stack device of claim 14, wherein the laser and photodetector layer is formed with the TIA/Driver EIC layer on the processing layer based on a flip-chip bonding procedure.

18. A 3D co-packaged optics (CPO) stack device, comprising:
a thermal management and control layer;
a printed circuit board (PCB) layer;
a processing layer, wherein the processing layer receives control signals from the thermal management and control layer;
a transimpedance amplifier and driver (TIA/Driver) electrical integrated circuit (EIC) layer;
a photonic integrated circuit (PIC) layer;
an optical interposer layer, wherein the optical interposer layer comprises a plurality of vias that are configured to guide light through the optical interposer layer; and
an optical fiber array coupled to the optical interposer layer;
wherein the thermal management and control layer is positioned on a first surface of the PCB layer;
wherein a first surface of the processing layer is positioned on a second surface of the PCB layer, and wherein the second surface of the PCB layer is opposite the first surface of the PCB layer;
wherein a first surface of the TIA/Driver EIC layer is positioned on a second surface of the processing layer, and wherein the second surface of the processing layer is opposite the first surface of the processing layer;
wherein a first surface of the PIC layer is positioned on a second surface of the TIA/Driver EIC layer, and wherein the second surface of the TIA/Driver EIC layer is opposite the first surface of the TIA/Driver EIC layer; and
wherein a first surface of the optical interposer layer is positioned on a second surface of the PIC layer, and wherein the second surface of the PIC layer is opposite the first surface of the PIC layer.

19. The 3D CPO stack device of claim 18, wherein the optical fiber array is coupled to a second surface of the optical interposer layer, and wherein the second surface of the optical interposer layer is opposite the first surface of the optical interposer layer.

20. The 3D CPO stack device of claim 19, wherein a first end of the optical fiber array is coupled to the second surface of the optical interposer layer, the 3D CPO stack device further comprising:
a first fiber connector coupled to a first portion of the optical fiber array at a second end of the optical fiber array, wherein the first fiber connector provides a first redirected path for light from an original path provided by the optical fiber array; and
a second fiber connector coupled to a second portion of the optical fiber array at the second end of the optical fiber array, wherein the second fiber connector provides a second redirected path for light from an original path provided by the optical fiber array.
